(19) United States
(12) Patent Application Publication
(10) Pub. No.: US 2022/0116199 A1
(43) Pub. Date: Apr. 14, 2022

(54) METHOD AND APPARATUS FOR GENERATING SYNTHETIC DATA

(71) Applicant: SAMSUNG SDS CO., LTD., Seoul (KR)

(72) Inventors: Min Jung KIM, Seoul (KR); Ji Hoon CHO, Seoul (KR); Hyo Jin YOON, Seoul (KR); Young Hyun KIM, Seoul (KR); Kyoo Hyung HAN, Seoul (KR)

(21) Appl. No.: 17/500,013

(22) Filed: Oct. 13, 2021

(30) Foreign Application Priority Data
Oct. 13, 2020 (KR) 10-2020-0132247
Jun. 24, 2021 (KR) 10-2021-0082692

(51) Int. Cl. H04L 9/06; H04L 9/00; H04L 9/30; H04L 9/08; G06N 20/00

(52) U.S. Cl. CPC H04L 9/0631; H04L 9/008; G06N 20/00; H04L 9/0877; H04L 9/30

(57) ABSTRACT

An apparatus for generating synthetic data according to an embodiment includes a synthetic data generator configured to generate synthetic data corresponding to combined data obtained by combining original data held by each of a plurality of data providing apparatuses, and a synthetic data provider configured to provide the synthetic data to a data using apparatus.

### CROSS-REFERENCE TO RELATED APPLICATION(S) AND CLAIM OF PRIORITY

This application claims the benefit under 35 USC § 119(a) of Korean Patent Application Nos. 10-2020-0132247, filed on Oct. 13, 2020 and 10-2021-0082692, filed on Jun. 24, 2021, in the Korean Intellectual Property Office, the entire disclosure of which is incorporated herein by reference for all purposes.

### BACKGROUND

### 1. Field

The following description relates to a technology for generating synthetic data.

### 2. Description of Related Art

In data analysis, data combining is a widely used approach to improve the performance of analysis. However, it is virtually impossible for multiple organizations to share data containing personal information with each other and combine the data due to various regulations such as the Personal Information Protection Act, the General Data Protection Regulation (GDPR), and the Health Insurance Portability and Accountability Act (HIPPA). In order to avoid such legal regulations, de-identification techniques are often used, but even de-identified data has an increased risk of exposure after combining. In addition, in the related art, the data privacy protection technology uses encrypted (or protected) data, and thus a problem arises in that a method for satisfying the technology has to be devised according to an analysis query, which may lead to an increased time and complexity of the entire data analysis process.

### SUMMARY

Embodiments disclosed in the present disclosure are to provide a method and apparatus for generating synthetic data.

In one general aspect, there is provided an apparatus for generating synthetic data according to an embodiment including: a synthetic data generator configured to generate synthetic data corresponding to combined data obtained by combining original data held by each of a plurality of data providing apparatuses; and a synthetic data provider configured to provide the synthetic data to a data using apparatus.

The synthetic data generator may receive a ciphertext for the original data from each of the plurality of data providing apparatuses, and generate the synthetic data based on the received ciphertext.

The synthetic data generator may decrypt the ciphertext received from each of the plurality of data providing apparatuses in a trusted execution environment (TEE), generate the combined data by combining each original data piece generated through the decryption in the TEE, and generate the synthetic data based on the generated combined data in the TEE.

The ciphertext for the original data may be a ciphertext generated by each of the plurality of data providing apparatuses by using a homomorphic encryption algorithm.

The synthetic data generator may generate a ciphertext for the combined data by using the ciphertext received from each of the plurality of data providing apparatuses in an encrypted state, and generate a ciphertext for the synthetic data by using the ciphertext for the combined data in an encrypted state, and the synthetic data generator may provide the ciphertext for the synthetic data to the data using apparatus.

The synthetic data generator may generate the synthetic data by using a multi-party computation protocol in which the plurality of data providing apparatuses participate.

The synthetic data generator may generate the synthetic data by using a machine learning-based synthetic data generation model.

The synthetic data generation model may be a pre-trained model to generate synthetic data satisfying differential privacy.

In another general aspect, there is provided a method for generating synthetic data, the method including: generating synthetic data corresponding to combined data obtained by combining original data held by each of a plurality of data providing apparatuses; and providing the synthetic data to a data using apparatus.

The generating may include receiving a ciphertext for the original data from each of the plurality of data providing apparatuses, and generating the synthetic data based on the received ciphertext, and generating the synthetic data based on the received ciphertext.

The generating of the synthetic data based on the received ciphertext may include: decrypting the ciphertext received from each of the plurality of data providing apparatuses in a trusted execution environment (TEE); generating the combined data by combining each original data piece generated through the decryption in the TEE; and generating the synthetic data based on the generated combined data in the TEE.

The ciphertext for the original data may be a ciphertext generated by each of the plurality of data providing apparatuses by using a homomorphic encryption algorithm.

The generating of the synthetic data based on the received ciphertext may include: generating a ciphertext for the combined data by using the ciphertext received from each of the plurality of data providing apparatuses in an encrypted state; and generating a ciphertext for the synthetic data by using the ciphertext for the combined data in an encrypted state, and the providing may include providing the ciphertext for the synthetic data to the data using apparatus.

The generating of the synthetic data may include generating the synthetic data by using a multi-party computation protocol in which the plurality of data providing apparatuses participate.

The generating of the synthetic data may include generating the synthetic data by using a machine learning-based synthetic data generation model.

The synthetic data generation model may be a pre-trained model to generate synthetic data satisfying differential privacy.

### BRIEF DESCRIPTION OF THE DRAWINGS

FIG. 1 is a configuration diagram of a data analysis system according to an embodiment.

FIG. 2 is a configuration diagram of an apparatus for generating synthetic data according to an embodiment.

FIG. 3 is a flowchart of a method for generating synthetic data according to an embodiment.

FIG. 4 is a flowchart of a process of generating synthetic data according to an embodiment.

FIG. 5 is a flowchart of a process of generating synthetic data according to another embodiment.

FIG. 6 is a block diagram for exemplarily illustrating a computing environment including a computing device according to an embodiment.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice or the intention of a user or operator. Thus, the definitions should be determined based on the overall content of the present specification. The terms used herein are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

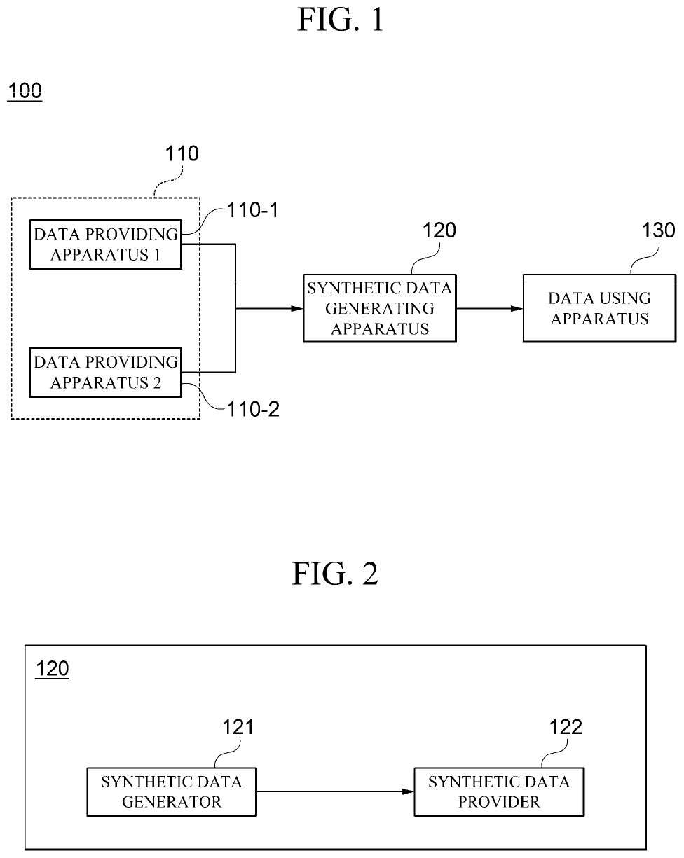

FIG. 1 is a configuration diagram of a data analysis system according to an embodiment.

Referring to FIG. 1, a data analysis service system 100 according to an embodiment includes a plurality of data providing apparatuses 110, an apparatus for generating synthetic data (synthetic data generating apparatus) 120, and a data using apparatus 130.

The plurality of data providing apparatuses 110 are apparatuses each possessing original data to be analyzed by the data using apparatus 130.

In this case, that the data providing apparatus 110 possesses the original data may mean that the data providing apparatus 110 stores the original data in a storage means provided therein, or is able to obtain the original data by accessing an external device storing the original data.

Meanwhile, original data may be data including, for example, sensitive information that is prohibited from disclosure to third parties not authorized by law, such as genetic data, medical records, financial transaction information (for example, account number and bank statement), or personally identifiable information (for example, name and resident registration number), or that is required to be kept confidential according to personal privacy protection and security needs.

Meanwhile, in the embodiment illustrated in FIG. 1, the number of data providing apparatuses 110 is exemplified as two; however, the number of data providing apparatuses 110 is not necessarily limited to the illustrated example, and may be changed according to embodiments.

The synthetic data generating apparatus 120 is an apparatus for generating synthetic data corresponding to combined data obtained by combining original data held by each of a plurality of data providing apparatuses 110 and providing the generated synthetic data to the data using apparatus 130.

According to an embodiment, synthetic data for the combined data means data having the same or similar statistical characteristics as the combined data, and may be generated to satisfy differential privacy according to an embodiment.

The data using apparatus 130 is an apparatus for generating an analysis result for combined data corresponding to the synthetic data by using the synthetic data provided from the synthetic data generating apparatus 120.

According to an embodiment, the analysis result for the combined data may be, for example, a result for various types of data analysis for generating, detecting, or extracting meaningful new information related to the combined data, such as predictive analysis, statistical analysis, classification, or clustering, and is not necessarily limited to a specific type of analysis result.

FIG. 2 is a configuration diagram of a synthetic data generating apparatus according to an embodiment.

Referring to FIG. 2, the synthetic data generating apparatus 120 according to an embodiment includes a synthetic data generator 121 and a synthetic data provider 122.

According to an embodiment, the synthetic data generator 121 and the synthetic data provider 122 may be implemented by one or more processors or a combination of one or more processors and software, and may not be clearly distinguished in specific operations, unlike the illustrated example.

The synthetic data generator 121 generates synthetic data corresponding to combined data obtained by combining original data held by each of a plurality of data providing apparatuses 110.

According to an embodiment, the synthetic data generator 121 may receive a ciphertext for the original data held by each of the plurality of data providing apparatuses 110 from each data providing apparatus 110, and may generate synthetic data for the combined data based on the ciphertext received from each data providing apparatus 110.

Specifically, according to an embodiment, the ciphertext received from the plurality of data providing apparatuses 110 may be, for example, a ciphertext encrypted using symmetric key encryption algorithms such as the advanced encryption standard algorithm (AES) and the data encryption standard algorithm (DES), or public key encryption algorithms such as the Rivest, Shamir, Adleman (RSA) algorithm and the ElGamal algorithm.

In this case, each data providing apparatus 110 may encrypt the original data held by the data providing apparatus 110, for example, by using an encryption key shared in advance with the synthetic data generating apparatus 120 using the Diffie-Hellman key exchange protocol or a public key disclosed by the synthetic data generating apparatus 120, and then provide the ciphertext generated through the encryption to the synthetic data generating apparatus 120.

In addition, the synthetic data generator 121 may decrypt the ciphertext received from each data providing apparatus 110 by using the encryption key shared in advance with each data providing apparatus 110 or a private key corresponding to the public key, and then generate combined data by combining each decrypted original data piece.

Meanwhile, according to an embodiment, the synthetic data generator 121 may generate synthetic data for the combined data by using a machine learning-based synthetic data generation model. Specifically, the synthetic data generation model may be, for example, a pre-trained model to generate synthetic data for input data based on an artificial neural network such as a generative adversarial network (GAN). As another example, the synthetic data generation model may be a pre-trained model to generate synthetic data satisfying differential privacy, such as a differential private generative adversarial network (DP-GAN). The synthetic data generator 121 may generate synthetic data for the combined data by using various well-known synthetic data generation techniques in addition to the above-described examples.

Meanwhile, in the above-described embodiment, the synthetic data generator 121 may perform decryption of the ciphertext, generation of combined data, and generation of synthetic data in a trusted execution environment.

According to another embodiment, the ciphertext received from the plurality of data providing apparatuses 110 may be a ciphertext encrypted by using the homomorphic encryption algorithm. In this case, the homomorphic encryption algorithm means an encryption algorithm capable of generating a ciphertext for the result of performing a specific operation on the original data by using the ciphertext for the original data in an encrypted state. Meanwhile, the homomorphic encryption algorithm used to generate the ciphertext for the original data is not necessarily limited to a specific algorithm, and various known homomorphic encryption algorithms may be used in consideration of the type and efficiency of operations to be performed for data combination and synthetic data generation.

Specifically, when a ciphertext encrypted using the homomorphic encryption algorithm is received from each of the plurality of data providing apparatuses 110, the synthetic data generator 121 may generate the ciphertext for the combined data in which the original data corresponding to each ciphertext is combined by combining each received ciphertext in an encrypted state.

In addition, the synthetic data generator 121 may generate a ciphertext for synthetic data corresponding to the combined data by using the generated ciphertext for the combined data in an encrypted state. Specifically, the synthetic data generator 121 may generate the ciphertext for the synthetic data by performing an operation using the combined data generation model by using the ciphertext for the combined data in an encrypted state.

Meanwhile, according to still another embodiment, the synthetic data generator 121 may generate the synthetic data by using a multi-party computation protocol in which the plurality of data providing apparatuses 110 participate. Specifically, the synthetic data generator 121 may generate the synthetic data for the combined data by performing an operation for generating the synthetic data using the combined data generation model through a multi-party computation protocol with each data providing apparatus 110. In this case, the multi-party computation protocol is not necessarily limited to a specific method, and various known multi-party computation methods may be used.

The synthetic data provider 122 provides the synthetic data generated by the synthetic data generator 121 to the data using apparatus 130.

In this case, according to an embodiment, the synthetic data generated by the synthetic data generator 121 may be synthetic data encrypted using the homomorphic encryption algorithm.

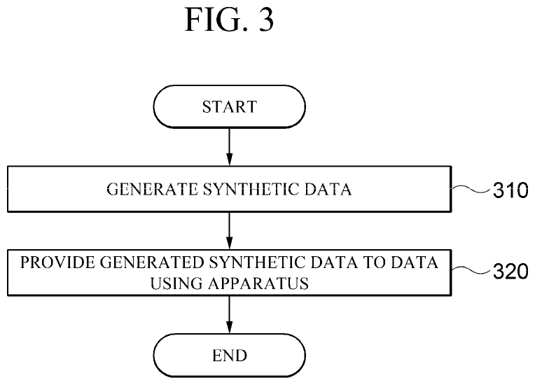

FIG. 3 is a flowchart of a method for generating synthetic data according to an embodiment.

The method illustrated in FIG. 3 may be performed by the synthetic data generating apparatus 120.

Referring to FIG. 3, first, the synthetic data generating apparatus 120 generates synthetic data corresponding to combined data obtained by combining original data held by each of a plurality of data providing apparatuses 110 (310).

In this case, according to an embodiment, the synthetic data generating apparatus 120 may receive a ciphertext for original data from each of the plurality of data providing apparatuses 110, and generate the synthetic data based on the received ciphertext.

Meanwhile, according to another embodiment, the synthetic data generating apparatus 120 may generate the synthetic data by using a multi-party computation protocol in which the plurality of data providing apparatuses 110 participate.

Then, the synthetic data generating apparatus 120 provides the generated synthetic data to the data using apparatus 130 (320).

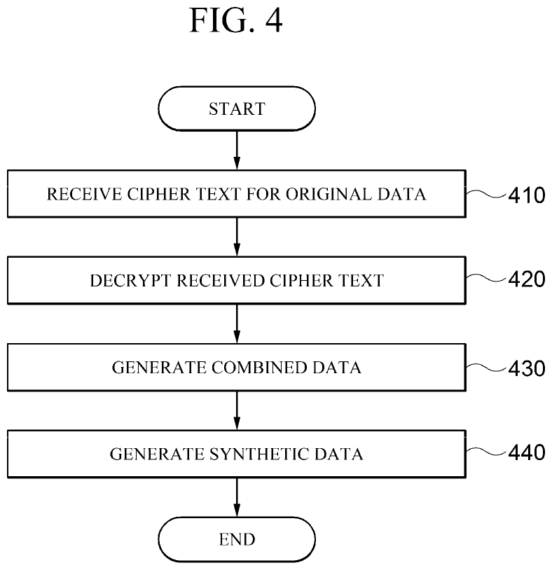

FIG. 4 is a flowchart of a process of generating synthetic data according to an embodiment.

The process illustrated in FIG. 4 may be performed in step 310 illustrated in FIG. 3.

Referring to FIG. 4, first, the synthetic data generating apparatus 120 receives a ciphertext for original data held by each of the plurality of data providing apparatuses 110 from each data providing apparatus 110 (410).

Then, the synthetic data generating apparatus 120 decrypts a ciphertext received from each data providing apparatus 110 in a trusted execution environment (420).

Then, the synthetic data generating apparatus 120 generates combined data by combining each original data piece generated through the decryption in the trusted execution environment (430).

Then, the synthetic data generating apparatus 120 generates synthetic data corresponding to the combined data in the trusted execution environment (440).

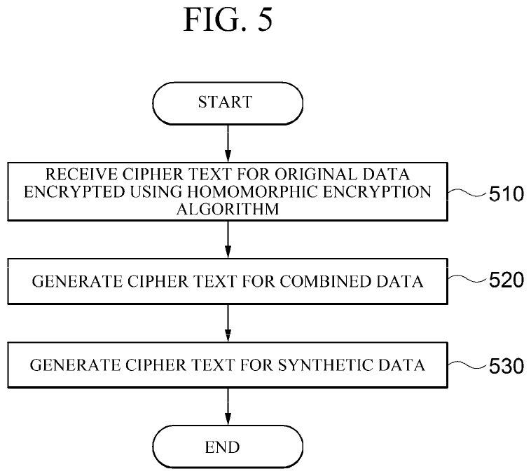

FIG. 5 is a flowchart of a process of generating synthetic data according to another embodiment.

The process illustrated in FIG. 5 may be performed in step 310 illustrated in FIG. 3.

Referring to FIG. 5, first, the synthetic data generating apparatus 120 receives a ciphertext for original data encrypted using the homomorphic encryption algorithm from each of the plurality of data providing apparatuses 110 (510).

Then, the synthetic data generating apparatus 120 generates a ciphertext for combined data in which original data for the ciphertext received from each data providing apparatus 110 is combined, by using each received ciphertext in an encrypted state (520).

Then, the synthetic data generating apparatus 120 generates a ciphertext for synthetic data corresponding to the combined data by using the ciphertext for the combined data in an encrypted state (530).

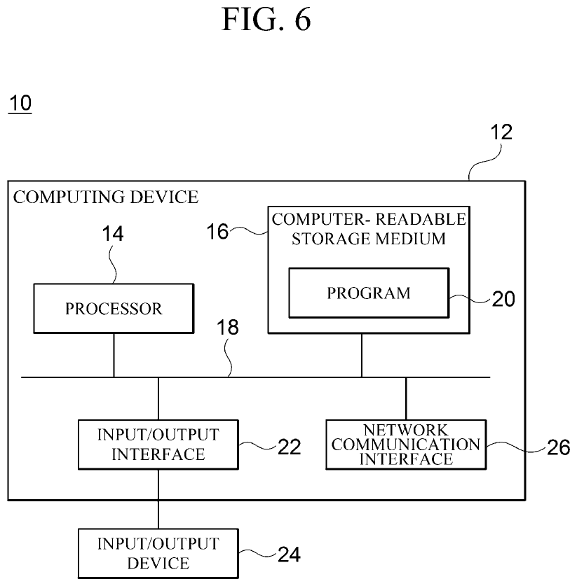

FIG. 6 is a block diagram for exemplarily illustrating a computing environment including a computing device according to an embodiment.

In an embodiment illustrated in FIG. 6, each component may have different functions and capabilities in addition to those described below, and additional components may be included in addition to those described below.

The illustrated computing environment 10 includes a computing device 12. In an embodiment, the computing device 12 may be one or more components included in the synthetic data generating apparatus 120 illustrated in FIG. 2.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touchpad, a touch screen, or the like), a voice or sound input device, input devices such as various types of sensor devices and/or imaging devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

According to the disclosed embodiments, original data held by each data providing apparatus is combined in an encrypted (or protected) state under a data privacy protection technology, and thus data sharing between data providing apparatuses may not be required for data combining, and leakage of original data may be prevented.

Furthermore, the combined data is not provided directly to a data user, and instead, synthetic data, which is fake data with similar statistical properties to the combined data, is provided to the data user, and thus both the protection of the original data and the analysis efficiency may be secured.

Although the present disclosure has been described in detail through the representative embodiments as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

What is claimed is:

1. An apparatus for generating synthetic data, the apparatus comprising:
a synthetic data generator configured to generate synthetic data corresponding to combined data obtained by combining original data held by each of a plurality of data providing apparatuses; and
a synthetic data provider configured to provide the synthetic data to a data using apparatus.

2. The apparatus of claim 1, wherein the synthetic data generator is further configured to receive a ciphertext for the original data from each of the plurality of data providing apparatuses, and generate the synthetic data based on the received ciphertext.

3. The apparatus of claim 2, wherein the synthetic data generator is further configured to decrypt the ciphertext received from each of the plurality of data providing apparatuses in a trusted execution environment (TEE), generate the combined data by combining each original data piece generated through the decryption in the TEE, and generate the synthetic data based on the generated combined data in the TEE.

4. The apparatus of claim 2, wherein the ciphertext for the original data is a ciphertext generated by each of the plurality of data providing apparatuses by using a homomorphic encryption algorithm.

5. The apparatus of claim 4, wherein the synthetic data generator is further configured to generate a ciphertext for the combined data by using the ciphertext received from each of the plurality of data providing apparatuses in an encrypted state, and generate a ciphertext for the synthetic data by using the ciphertext for the combined data in an encrypted state; and
the synthetic data provider is further configured to provide the ciphertext for the synthetic data to the data using apparatuses.

6. The apparatus of claim 1, wherein the synthetic data generator is further configured to generate the synthetic data by using a multi-party computation protocol in which the plurality of data providing apparatuses participate.

7. The apparatus of claim 1, wherein the synthetic data generator is further configured to generate the synthetic data by using a machine learning-based synthetic data generation model.

8. The apparatus of claim 7, wherein the machine learning-based synthetic data generation model is a pre-trained model to generate synthetic data satisfying differential privacy.

9. A method for generating synthetic data, the method comprising:
generating synthetic data corresponding to combined data obtained by combining original data held by each of a plurality of data providing apparatuses; and
providing the synthetic data to a data using apparatus.

10. The method of claim 9, wherein the generating comprises:
receiving a ciphertext for the original data from each of the plurality of data providing apparatuses; and
generating the synthetic data based on the received ciphertext.

11. The method of claim 10, wherein the generating of the synthetic data based on the received ciphertext comprises:
decrypting the ciphertext received from each of the plurality of data providing apparatuses in a trusted execution environment (TEE);
generating the combined data by combining each original data piece generated through the decryption in the TEE; and
generating the synthetic data based on the generated combined data in the TEE.

12. The method of claim 11, wherein the decrypting comprises using an encryption key shared in advance with each of the data providing apparatuses or a private key corresponding to a public key.

13. The method of claim 10, wherein the ciphertext for the original data is a ciphertext encrypted using a symmetric key encryption algorithm or a public key encryption algorithm.

14. The method of claim 11, wherein the ciphertext for the original data is a ciphertext encrypted using one selected from the group consisting of an advanced encryption standard algorithm (AES) and a data encryption standard algorithm (DES), Rivest, Shamir, Adleman (RSA) algorithm and an ElGamal algorithm.

15. The method of claim 10, wherein the ciphertext for the original data is a ciphertext generated by each of the plurality of data providing apparatuses by using a homomorphic encryption algorithm.

16. The method of claim 15, wherein the generating of the synthetic data based on the received ciphertext comprises:
generating a ciphertext for the combined data by using the ciphertext received from each of the plurality of data providing apparatuses in an encrypted state; and
generating a ciphertext for the synthetic data by using the ciphertext for the combined data in an encrypted state, and
the providing comprises providing the ciphertext for the synthetic data to the data using apparatuses.

17. The method of claim 9, wherein the generating of the synthetic data comprises generating the synthetic data by using a multi-party computation protocol in which the plurality of data providing apparatuses participate.

18. The method of claim 9, wherein the generating of the synthetic data comprises generating the synthetic data by using a machine learning-based synthetic data generation model.

19. The method of claim 18, wherein the machine learning-based synthetic data generation model is a pre-trained model to generate synthetic data satisfying differential privacy.
